(19) United States
(12) Patent Application Publication
(10) Pub. No.: US 2023/0165218 A1
(43) Pub. Date: Jun. 1, 2023

(54) CAT SCRATCHER PERCH KIT AND METHOD OF ASSEMBLY

(71) Applicant: WORLDWISE, INC., Novato, CA (US)

(72) Inventors: Jacob Dominguez, Mercedes, TX (US); Aimee Diskin, Napa, CA (US); Julie Widenhofer, San Anselmo, CA (US); Michael Russo, Napa, CA (US); Hanah Rosenberg, San Francisco, CA (US); Lisa Davis, Novato, CA (US); Shiyu Guo, Tiburon, CA (US)

(21) Appl. No.: 17/539,175

(22) Filed: Nov. 30, 2021

(51) Int. Cl. A01K 15/02

(52) U.S. Cl. CPC A01K 15/024

(57) ABSTRACT

A cat scratcher kit and method of assembly. The kit includes first and second corrugated cardboard blocks, each corrugated cardboard block having top and bottom curvilinear surfaces of exposed open cardboard flutes such that the top surface of the first corrugated cardboard block nests coextensively with the bottom surface of the second corrugated cardboard block in a first orientation. Each of the first and second corrugated cardboard blocks have a notch configured therein such that the first and second corrugated cardboard blocks are joined to one another through joinder of the notches forming a corrugated cardboard perch having a substantially X-profile in a second orientation. The first and second corrugated cardboard blocks are composed of a plurality of corrugated subparts, each corrugated subpart being a corrugated sheet having top and bottom surfaces and a planar sheet of kraft paper adhered to the top surface and a planar sheet of kraft paper adhered to the bottom surface, the top and bottom surfaces being adhered to the planar sheets of kraft paper through the use of an aqueous-based adhesive, the aqueous-based adhesive being a catnip or silvervine hydrosol.

### TECHNICAL FIELD

The present invention is directed to a kit for assembling a cat scratcher perch as well as a method for such assembly. The cat scratcher perch is in the form of open-fluted corrugated cardboard blocks which, once assembled, is substantially X-shaped and supportive of a pet cat which not only provides support for the cat but also an ideal scratching surface as well as being an elevated perch location that fosters a sense of security and other benefits. The corrugate blocks include catnip or silvervine as attractants to encourage the cat to use the perch as opposed to satisfying its natural scratching instinct on furniture, drapes and the like. Rather than merely applying catnip or silvervine to the surface of the perch, it has been determined that significant benefit can be derived by incorporating catnip or silvervine into an aqueous-based adhesive.

### BACKGROUND OF THE INVENTION

It is quite important for the health and well-being of a pet to not only be fed properly but also be provided stimulating activities. Pets which become bored oftentimes become destructive not only of their surroundings but also themselves. Animals which are not appropriately stimulated can actually suffer adverse health effects and as a consequence, proper pet stimulation should be a significant consideration for virtually all pet owners.

In addition to pet stimulation, generally, pet cats require surfaces upon which they can lounge, scratch, hide or perform other activities. If an appropriate scratching surface is not provided, cats will use any available surface, including upholstered furniture, drapes and rugs to satisfy their need to scratch potentially causing significant damage.

There have been a variety of cat scratching devices available in the marketplace for quite some time. The most successful of such devices have surfaces which will eventually be worn requiring replacement. Such surfaces include, for example, carpet, sisal, corrugated cardboard, rope and natural fibers.

To stimulate a pet cat and to encourage it to selectively use a dedicated lounging and scratching device rather than furniture, rugs, drapes and the like, it is common to apply catnip or silvervine in the form of ground catnip or silvervine leaves to the scratcher surface. The effect of catnip and silvervine on virtually all feline species is well known. The dry leaves of the catnip and silvervine plants express a mint-like scent. They are euphoric stimulants, although they are not toxic. This “catnip response” is due to the plant's active ingredient, nepetalactone. Similar responses are observed as a result of silvervine's active ingredient actinidine.

Although traditional cat scratchers are applied to a rigid support and are thus self-supporting, such devices occupy significant space within one's household. In situations where space is at a premium, one cannot always employ self-supporting scratchers and alternatives must be found. Self-supporting scratchers are large and bulky and are thus expensive to ship as manufacturers are generally located offshore. This also results in high warehouse and display costs.

It is thus an object of the present invention to provide a cat scratcher with enhanced stimulating properties invoking the appropriate “catnip response.”

It is yet still a further object of the present invention to provide a cat scratcher composed of corrugate blocks with the appropriate catnip or silvervine constituents embedded therein and which has exposed open flutes on all of its planar surfaces in order to extend the useful life of such a product.

It is still a further object of the present invention to provide an easy to assemble kit creating an ideal lounger, hide-out and scratcher from a relatively small, compact package.

It is still a further object of the present invention to provide a cat scratcher which presents an ideal form factor for minimizing shipping and warehousing costs and yet which can convert into a scratcher capable of supporting a lounging cat while providing stimulation.

These and further examples will be more readily apparent when considering the following disclosure and appended claims.

### SUMMARY OF THE INVENTION

A cat scratcher kit comprising:

first and second corrugated cardboard blocks, each corrugated cardboard block having top and bottom curvilinear surfaces of exposed open cardboard flutes such that the top surface of the first corrugated cardboard block nests coextensively with the bottom surface of the second corrugated cardboard block in a first orientation;
each of said first and second corrugated cardboard blocks having a notch configured therein such that said first and second corrugated cardboard blocks are joined to one another through joinder of said notches forming a corrugated cardboard perch having a substantially X-profile in a second orientation;
said first and second corrugated cardboard blocks composed of a plurality of corrugated subparts, each corrugated subpart comprising a corrugated sheet having top and bottom surfaces and a planar sheet of kraft paper adhered to said top surface and a planar sheet of kraft paper adhered to said bottom surface, said top and bottom surfaces being adhered to said planar sheets of kraft paper through the use of an aqueous-based adhesive, said aqueous-based adhesive comprising catnip or silvervine hydrosol.
A method of assembling a cat scratcher perch, said method comprising providing first and second corrugated cardboard blocks, each corrugated cardboard block having top and bottom curvilinear surfaces of exposed open cardboard flutes such that the top surface of the first corrugated cardboard block nests coextensively with the bottom surface of the second corrugated cardboard block in a first orientation, each of said first and second corrugated cardboard blocks having a notch configured therein and wherein;
said method comprising separating said first and second cardboard blocks from their first orientation and joining said first and second corrugated cardboard blocks at their respective notches forming a substantially X-shaped perch in a second orientation with exposed open cardboard flutes for supporting a cat thereon.

### BRIEF DESCRIPTION OF THE FIGURES

FIG. 1 is a perspective view of the cat scratcher kit in is first (unassembled) orientation.

FIG. 2A is a plan view of the components of the cat scratcher kit moved from its first orientation for assembly.

FIG. 2B is a perspective view of the components of the cat scratcher kit as the components are aligned for further assembly.

FIG. 2C is a perspective view of the cat scratcher perch as assembled for use.

FIG. 3A is a perspective view of a corrugated block as employed in the present cat scratcher perch.

FIG. 3B is a perspective view of the detail of the cardboard block of FIG. 3A.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

The present invention represents a solution to a number of issues involving the cost of shipping and storing cat scratchers and their employment in a pet owner's home used to satisfy a cat's inherent need to scratch as well as reducing boredom which would otherwise result in destructive behavior.

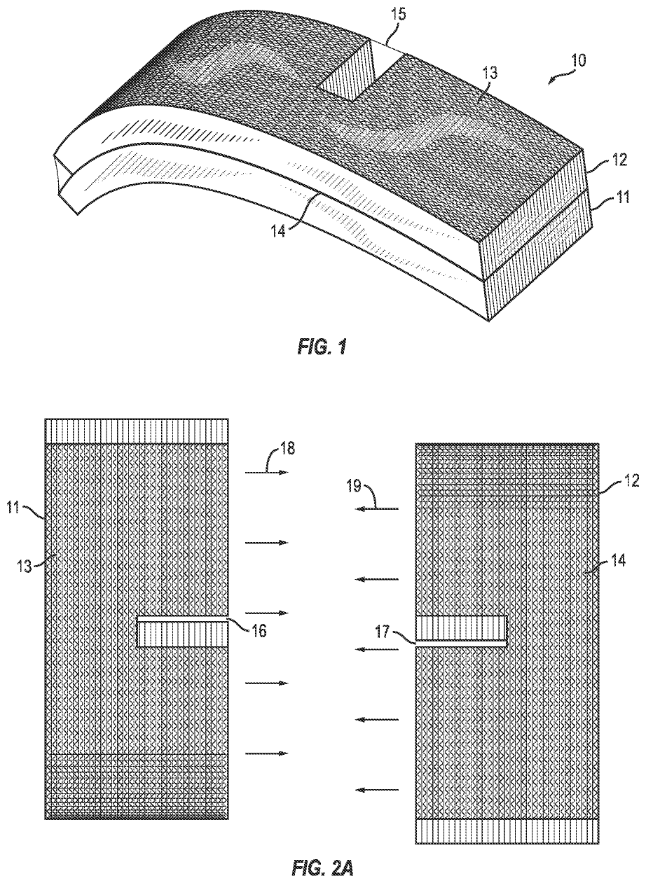

In turning to FIG. 1, the present cat scratcher kit 10 is shown as it would be shipped from its manufacturer warehoused by a seller and supported on a retailer's shelf for in-store display.

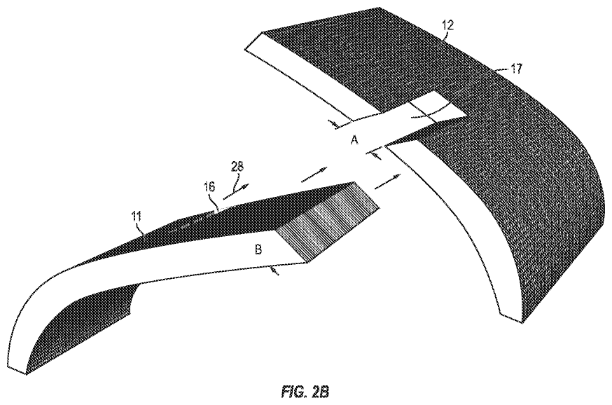

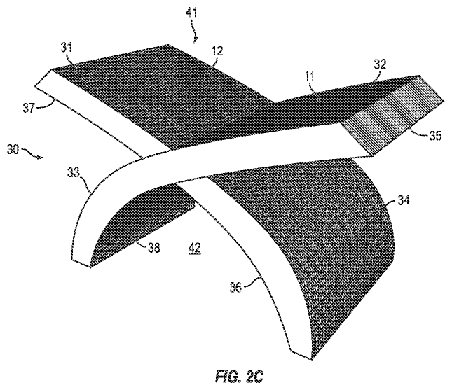

Cat scratcher kit 10 is composed of first and second corrugated cardboard blocks 11 and 12 having top and bottom curvilinear surfaces 13 and 14 which are generally nested coextensively with one another and held in their nested or first orientation by clear plastic or cellophane wrapping 15 which also helps to preserve the effectiveness of the catnip and silvervine components contained therein. In considering FIGS. 2A-2C, the method of converting the nested and wrapped cardboard blocks to the final perch is illustrated.

As noted in FIG. 2A, once plastic or cellophane wrapping 15 is removed, cardboard blocks 11 and 12 are separated from one another with notches 16 and 17 facing one another. At that point, cardboard blocks 11 and 12 move with respect to one another in the direction of arrows 18, 19 and 28 and are joined to one another through the joinder of notches 16 and 17 creating perch 30 generally having a substantially X-profile as shown in FIG. 2C.

As the width A of each notch is approximately equal to the width B of each corrugated cardboard block, corrugated cardboard blocks 11 and 12, when joined through notches 16 and 17 are frictionally retained to create perch 30 without requiring any adhesive or other joinder means. As such, when the pet owner wishes to store perch 30, corrugated cardboard blocks 11 and 12 can be disengaged from one another and the blocks re-nested.

As is noted from the various figures, corrugated cardboard blocks 11 and 12 display open flutes which represent a preferred scratching surface for a cat is able to dig its claws within the flutes. As constructed, open flutes are exposed on all surfaces identified as surfaces 31 through 38 which helps to maximize the life of perch 30 as cardboard is easily abraded by a cat digging its claws within fluted openings. Also, a cat can employ perch 30 as a scratcher whether it is lounging upon top surface 41 or secluded within the scratcher in area 42 as a hide out as well as in residing adjacent perch 30 in scratching surfaces 33 and 34. In addition, once a top surface is worn, the scratcher can be flipped 180° to present a fresh scratching and lounging surface to the pet as well as an area below the curved surface which creates a space for a cat to hide out providing a sense of security.

It is noted that corrugated cardboard blocks 11 and 12 can be fabricated pursuant to the teachings of U.S. Pat. No. 10,111,406, the disclosure which is incorporated by reference.

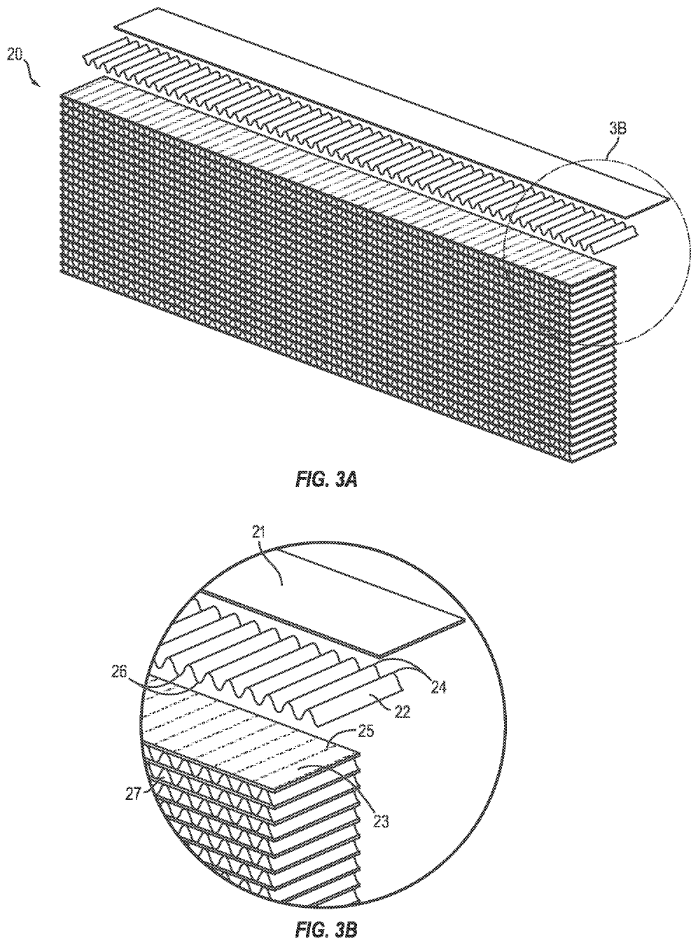

Specifically, FIGS. 3A and 3B depict the present invention as it applies to corrugate body 20 of corrugated cardboard. As is typically the case, corrugated cardboard comprises a plurality of corrugated subparts, specifically, corrugated sheet 22 having peaks 24 and corresponding valleys 26 and planar sheets of kraft paper 21 and 23 separating each corrugated sheet. Beads of adhesive 25 are applied to the kraft paper such that when corrugated sheet 12 is positioned between opposing sheets of kraft paper 21 and 23, cardboard body 20 is fabricated as a singular block. Generally, starch or dextrin-based adhesives are employed as they are non-toxic and thus pose no health risk to an engaging cat.

In the fabrication of prior cardboard-based scratchers, a common adhesive is employed to glue corrugated and planar sheets together and, if desired, ground catnip or silvervine leaves are sprinkled onto the flutes of the finished cardboard block. As the catnip or silvervine is readily available to the pet, it is quickly dissipated and provides the scratcher with no long-term stimulating effects. As a solution to this deficiency inherent in prior scratchers, the present invention employs a catnip or silvervine hydrosol in a suitable aqueous-based adhesive to create beads 25. It has been found that, in doing so, the integrity of the adhesive is not compromised and yet the desired stimulating effects are available for virtually the entire life of the scratcher.

Furthermore, catnip or silvervine hydrosol, alone, or with chopped catnip leaves can be sprayed onto the surface of scratcher body 11 employing, for example, an HVLP automatic spray gun to provide catnip or silvervine within the flutes created by corrugated sheets 22. This further enhances the stimulating effects of the scratcher noting that the catnip or silvervine hydrosol penetrates deeply within the flutes and, being a liquid, is absorbed by kraft paper sheets 21 and 23 as well as corrugated sheet 22. Solids, in the nature of chopped catnip or silvervine leaves and/or catnip or silvervine biomass can be included with the catnip or silvervine hydrosol to vary the viscosity of spray 25 to prevent the spray from passing through scratcher body 10 without residing within the flutes as desired employing a proprietary blend of catnip hyrdosol and catnip biomass. In one aspect, the corrugate blocks have catnip or silvervine attractants embedded in between the corrugate layers to help reduce mess to benefit the consumer.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A cat scratcher kit comprising:
first and second corrugated cardboard blocks, each corrugated cardboard block having top and bottom curvilinear surfaces of exposed open cardboard flutes such that the top surface of the first corrugated cardboard block nests coextensively with the bottom surface of the second corrugated cardboard block in a first orientation;
each of said first and second corrugated cardboard blocks having a notch configured therein such that when said first and second corrugated cardboard blocks are joined to one another through joinder of said notches, a corrugated cardboard perch having a substantially X-profile is formed in a second orientation;
said first and second corrugated cardboard blocks composed of a plurality of corrugated subparts, each corrugated subpart comprising a corrugated sheet having top and bottom surfaces and a planar sheet of kraft paper adhered to said top surface and a planar sheet of kraft paper adhered to said bottom surface, said top and bottom surfaces being adhered to said planar sheets of kraft paper through the use of an aqueous-based adhesive, said aqueous-based adhesive comprising catnip or silvervine hydrosol.

2. A method of assembling a cat scratcher perch, said method comprising providing first and second corrugated cardboard blocks, each corrugated cardboard block having top and bottom curvilinear surfaces of exposed open cardboard flutes such that the top surface of the first corrugated cardboard block nests coextensively with the bottom surface of the second corrugated cardboard block in a first orientation, each of said first and second corrugated cardboard blocks having a notch configured therein and wherein;
said method comprising separating said first and second cardboard blocks from their first orientation and joining said first and second corrugated cardboard blocks at their respective notches forming a substantially X-shaped perch in a second orientation with exposed open cardboard flutes for supporting a cat thereon.

3. The method of claim 2 wherein said corrugate cardboard blocks are prepared by joining a plurality of corrugated subparts, each corrugated subpart comprising a corrugated sheet having top and bottom surfaces and a planar sheet of kraft paper adhered to said top surface and a planar sheet of kraft paper adhered to said bottom surface, said top and bottom surfaces being adhered to the planar sheets of kraft paper through the use of an aqueous-based adhesive, said aqueous-based adhesive comprising a catnip or silvervine hydrosol.
